(19) United States
(12) Patent Application Publication
(10) Pub. No.: US 2011/0078941 A1
(43) Pub. Date: Apr. 7, 2011

(54) Trap for insects

(76) Inventor: Steven Mathena, Fort Myers, FL (US)

(21) Appl. No.: 12/587,189

(22) Filed: Oct. 5, 2009

(51) Int. Cl. A01M 1/10

(52) U.S. Cl. 43/107

(57) ABSTRACT

An insect trap, particularly for roaches. The insect trap consists of a standard normally fluid containing container. An insect trap is inserted into an opening of the container. The insect trap is made of a cylindrical clear plastic container and has a multiplicity of holes in its wall to enhance the spread of the fumes of the bait that is placed into the trap. The bottom of the cylindrical trap is slanted and a hinged flap is placed over the open end of the cylindrical trap. The flap is hinged at one side of the edge of the opening and is biased into a closed position so that any insects within the trap can exit at the lower end but cannot return to escape from the container.

### BACKGROUND OF THE INVENTION

The present invention relates to a trap for insects, particularly to a trap for a roaches. Various traps are known that use containers having entry ways which allow insects to enter therein because they are attracted by a bait that is contained therein but will not allow the insects to escape there from once they are inside the container.

One such invention is disclosed in U.S. Pat. No. 6,158,165 which uses a standard normally fluid containing container which has an entry way that will prevent any insects that have entered therein from escaping. One disadvantage of this insect trap is that the bait is contained in the bottom of the container and the insects will have to be attracted by the bait that is in the bottom of the container. The one way trap is located in the entry way of the container.
Another known trap is disclosed in U.S. Pat. No. 1,618,513 where a standard container is used to place a trap design at the entrance to the container. The disclosed trap is acting one way, that is, the animal can easily enter to get to the bait but cannot exit again because of a self-acting trap that automatically closes when the animal has entered the container insert. Again, the bait is located in the bottom od the container.
Another insect trap is disclosed in U.S. Pat. No. 2,741,066 which uses absorbent material at the entrance of a standard container which attracts the insects. The absorbent material is kept in place in pockets which are held in place by way of receptacles that converge on each other toward the interior of container. The converging receptacles finally form a very narrow passage which prevents the once captured insects from returning to the outside of the container.

### BRIEF DESCRIPTION OF THE INVENTION

The inventive concept is intended to be applied to a standard normally fluid containing container. Such as a one gallon jug of water, a one gallon jug container for milk or other gallon containers for other fluids. At the entrance of the container there is placed a cylindrical plastic or clear plastic insect trap that has a top that is fitted to the entrance of the container. The bottom of the trap has a slanted opening that resembles an ellipse. At the bottom of this opening there is placed a self-closing flap that may be opened by the weight of the insect but closes itself by virtue of a plastic hinge that is placed at one edge of the opening. A bait material is placed within this cylindrical trap. A great advantage of placing this bait at this location is in that that it is far more efficient for its intended use. Being located at the entrance to the container, it attracts the insects much easier because of the proximity to the entrance of the container rather being placed in the bottom of the container. Of course, by placing the bait in the trap inside the container, the safety factor of the overall design is enhanced to a great extent. No animal or children can get into the bait container because the bait containing cylinder is locked inside the entrance to the container

### BRIEF DESCRIPTION OF THE DRAWINGS

FIG. 1 shows the insect trap placed at the entrance to a container;

FIG. 2 illustrates the trap itself;

FIG. 3 shows the top of the insect trap;

FIG. 4 shows a single bait container;

FIG. 5 illustrates how several bait containers are ganged together.

### DETAILED DESCRIPTION OF THE INVENTION

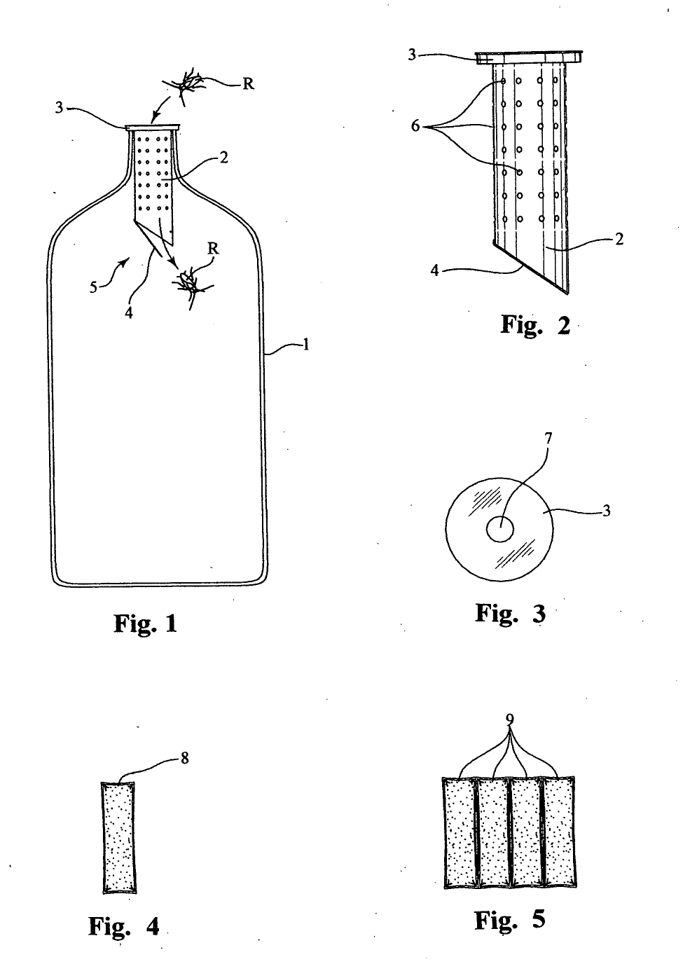

FIG. 1 shows a standard fluid container 1 having a cylindrical insect trap 2 placed within the entrance to the container 1. The container may be a gallon jug of water or other fluids that have been emptied there from. The container could also be a former milk containing jug. It is preferred that the container be a clear plastic so that any insects that have been trapped inside can be observed. The cap 3 of the container could be a snap-fitted cap or a screw-on type. The cap 3 of the insect trap 2 would have the same arrangement, by choice, so that the insect trap 2 is securely fastened to and within the top entrance of the container. The bottom edge of the cylindrical insect trap 2 is slanted to thereby form the semblance of an ellipse. The upper most edge of the slant has a flap 4 hinged thereto which forms a hinge that is so attached to the elliptical opening that it is always biased in a closing direction 5 to securely seat against the margins of the elliptical opening. The arrow in FIG. 1 shows an insect R that has opened the trap 4 by its own weight but the biased hinge returns the trap 4 to a closed position. It is preferred that a multiple of holes 6 be provided in the wall of the cylindrical bait 2. This will enhance the spread of the fumes of the bait and make it more attractive to the insects.

FIG. 3 shows the cap 3 of the cylindrical trap having an opening 7 which constitutes the entrance way of the trap. The insect will enter this opening 7 because it is attracted by the bait 8 therein which is close to the entrance.

FIG. 4 illustrates an example of a bait package 8. The bait can take many forms known to attract insects, particularly, roaches. Experimentation has shown that the well known “Frito Lay” in a ground up form is best suited for this purpose.

FIG. 5 simply shows how several packages of bait 9 my be ganged together so that multiple bait packages may be obtainer.

What I claim is:

1. A trap for insects comprising:
A standard fluid container being void of the fluid and having an opening, a cylindrical plastic trap is placed in said opening, said cylindrical trap having at the bottom thereof a slanted opening, a flap is placed at said opening to close the same, said flap is being hinged at one side thereof to an edge of said opening, said flap is biased into a closing position by a plastic self-closing hinge, insect attracting bait is placed within said cylindrical plastic trap.

2. The trap for insects of claim 1, said cylindrical plastic trap having a multiple of openings therein to enhance the spread of fumes attracting said insects.

3. The trap for insects of claim 1, said cylindrical plastic trap having a top which is form-fitted securely to a top of said fluid container.
